(19) United States
(12) Patent Application Publication
(10) Pub. No.: US 2007/0128238 A1
(43) Pub. Date: Jun. 7, 2007

(54) Method for masking feline attracting plant fragrances in human application

(76) Inventors: Deborah J. Brockman, Waikoloa, HI (US); Robert Brockman, Waikoloa, HI (US)

Correspondence Address: I. Michael Bak-Boychuk, P.O. Box 32501, Long Beach, CA, 90832, US

(21) Appl. No.: 11/296,548

(22) Filed: Dec. 7, 2005

(51) Int. Cl. A01N 65/00

(52) U.S. Cl. 424/405; 424/745; 424/750

(57) ABSTRACT

A method is described in which the essential oils of insect repelling plant matter are mixed with the essential oils of animal repelling matter so that the animal repelling scents mask the insect repelling scents from those animals that are attracted by the insect repelling plant matter. In this manner insect repelling plant oils such as catnip can be applied onto human skin in environments that also are inhabited by animals attracted by it. The mixture of these repelling agents can be suspended in plant oil to form a skin ointment or may be suspended in soap.

### BACKGROUND OF THE INVENTION

1. Field of the Invention

The present invention relates to a method and process for adapting natural plant fragrances for human use, and more particularly to a process and method for masking feline attracting aromatics and fragrances like catnip by other feline repelling natural fragrances.

2. Description of the Prior Art

It has long been recognized that some plant varieties produce and disperse scents, fragrances or other aromatic combinations that act as insect repellents. One such naturally occurring plant variety includes the plant known as catnip which has been widely recognized to have insect repelling properties, a conclusion recently confirmed in the course of U.S. Government sponsored research at the Iowa State University that culminated in U.S. Pat. No. 6,524,605 to Coats, et al. and its related published application 20030138471. While this confirming university research now firmly inscribes the insect repelling aspects of catnip into our banks of scientific knowledge, the suggested use of its unadulterated extract or concentrate as a biorational insect repellent, while certainly effective, fails to recognize its evolutionary consequence. Simply, along with the common knowledge now confirmed by thorough extensive research there is also the general observation that certain fastidious animals, particularly those in the cat family, are attracted by catnip.

Nature's efficiencies being what they are, these known insect repelling attributes of catnip and other similarly effective plants appear to have had their evolutionary effect amongst furry animals, particularly those of solitary habits. It has been generally observed that an asocial or antisocial behavior pattern seems to have a relationship with an observed attraction for the catnip plant, with the feline species particularly attracted by it, a general observation that even extends to the plant's nomenclature. Unsurprisingly, it is also this same genus that is known for its lack of convenient domestication, very effective hunting habits and an agile, robust and effective musculature provided with exquisite offensive tooling. Simply, the animal's solitary hunting habits and its inordinate attention to the care of its own fur coat appear to be symbiotic.

Cats, however, come in all sizes including scale dimensions that present some risk to an adult human, or more frequently a young child, a risk that is currently on the rise as human habitation patterns wholly invade what has been previously the wild cat's domain. These same growth patterns and rising density also increase the incidence of various cross-infections including those borne by insects (e.g., encephalitis) and therefore the consequent increased concentration of unwanted pesticides. Thus one now encounters an increasing size of intersections of the wild cat domains and the domain of human activity and the incidents of a disappearing young camper or jogger followed by a discovery of half eaten remains is no longer anectodal but an event of some frequency. The introduction into this mix of unadulterated catnip extract, as proposed by Coats, et al. in the '605 patent, for its known insect repelling properties can only result in the wholesale elimination of the wild cat that will be even further drawn towards all those wandering humans bathed in the purest extract of the attracting scent. Of course, in wholly segregated settings where the paths of humans never cross those of the wild cat the use of an unadulterated biorational repelling extract, as proposed by Coates et al., offers great advantages over synthetic pesticides and is therefore well suited for these intended purposes.

One separation that has not been generally appreciated is that imposed by scaling laws. Intuitive observation has long since concluded that organisms that are greatly disparate in size coexist in the same universes and, in fact, it is this ability to occupy the same space with impunity that renders microbial life such an effective companion of the larger scale species. Simply, the limited material densities, moments of inertia and strengths of organic matter define a specific time domain for each interval of scale that relates exponentially to the dimensional ratio. These scaling laws isolate and preclude effective interaction between the extremes of the scale and it has been the insect and its scaling niche that has provided the primary bridging mechanism for these two coexisting worlds. This bridging, disease carrying insect, i.e., the exact reason that has evolved the various grooming habits and the consequent species granulations along social and solitary lines, has therefore been the focus of varying synthetic insecticide and repellent. discoveries which, fortunately, because of their youth and synthetic form have so far had little evolutionary effect. Naturally occurring repellents like catnip, however, have a much longer interaction span within the evolutionary soup and thus accommodate the various bridging mechanisms across the extremes of scale. For the foregoing reasons the pure catnip extract proposed by Coats et al is useful primarily in sheltered human environments but not where other interactions can occur. A repellent that is mixed with other vapors to a ratio that targets the scale limited sensorium of an insect but offends the massive olfactory structures of a large scale animal is therefore the biorational mechanism that is extensively desired and it is one such mixture that is disclosed herein.

### SUMMARY OF THE INVENTION

Accordingly it is the general purpose and object of the present invention to mix insect repelling extracts with known animal repellents in a suspension that can be applied to the skin of a human.

Other objects of the invention are to combine the essential oils of plants known for their insect repelling attributes with the essential oils of animal repelling plants.

Yet additional objects of the invention are to blend the essential oils of insect repelling and animal repelling plants.

Yet further objects of the invention are to mask animal attracting scents that are known for their insect repelling attributes by other scents.

Briefly, these and other objects are accomplished within the present invention by combining several essential oils known or suggested for their insect repelling attributes together with the essential oil of catnip, known as Nepeta Cataria, with the catnip extract comprising the major constituent of the combination. Animal repelling essential oils are and then admixed into this combination such as the essential oil of lemongrass, known as Cymbopogen Flexuosus. Also added to this combination may be preservatives like the essential oil of the tea tree, known as Melaleuca Alternifolia, and further masking fragrances like lavender, or Lavendula Officinalis. Essential oil of citronella, or Cymbopoan Nardus, may also be admixed for its various antiseptic and further insect repelling attributes.

This blend of essential oils is then introduced, at a cumulative percentage range of 1.5 to 2.0 percent, into a carrier base comprising a 0-2:8 mixture of range olive oil and canola oil. In the foregoing form the resulting oily mixture may be directly applied to the skin surfaces of a person or the mixture can be further processed to form a solid soap by adding it into diluted sodium hydroxide in the well known lye process. The resulting soap triglycerides then in the presence of water break up the remaining oils into tiny droplets that are effectively dispersed in a film that fully covers the skin of the user.

Preferably the concentrations of the various essential oils and the carrier base are as follows:

| | | | |
|---|---|---|---|
| Catnip | [Nepeta Cataria] | 0.65 to 0.75% | Primary repellent; |
| Lemongrass | [Cymbopogen | 0.20 to 0.25% | Animal repellent; |
| | Flexuosus] | | |
| Tea tree | [Melaleuca | 0.28 to 0.32% | Preservative; |
| | Alternifolia] | | |
| Olive oil | | 0.0 to 20.0% | Thickening carrier; |
| Canola oil | | 80.0 to 100.0% | Primary carrier. |

To this mixture the following further essential oils can be admixed:

| | | | |
|---|---|---|---|
| Citronella | [Cymbopogen Nardus] | 0.12 to 0.17% | Secondary repellent; |
| Lavender | [Lavendula Officinalis] | 0.10 to 0.13% | Masking agent. |
| // | | | |
| // | | | |

Those skilled in the art will appreciate that the foregoing blend of essential oils is both at a very low concentration levels in the carrier and also in a wide array of scents and fragrances that tend to mask each other. Thus a large olfactory mechanism, like that of a cat, will be confused by the scent array that includes its own animal repellents like lemongrass (that often serves as a fertile habitat for poisonous snakes and the like.) Small scent discrimination mechanisms, like those of an insect, however, are not prone to this confusion or masking and thus are subject to the repellent's primary effect. Moreover, both the carriers are known for their low aromatic content and therefore low odor levels while at the same time being high in Omega 3 content, an antioxidant and cancer inhibiting constituent that may neutralize some of the hypersensitivities that humans occassionally exhibit in the presence of some plant growth. There is, therefore, an ancillary benefit obtained to ameliorate the perceptions of health hazard associated with insect repellents. Of course, where oily build-up on the user's skin is a matter of concern the content of the more viscous olive oil in the carrier may be reduced or wholly omitted.

These same masking and neutralizing aspects are also even more effective when emulsified and isolated by the surfactant process of a soap Simply, the scent emitted by localized droplets is even more prone to discrimination by an insect. Thus both forms obtain an array of competing scents that will tend to confuse a large animal but from which the insect may best discriminates its repellent.

Those skilled in the art will further appreciate that this array of competing scents may, however, be overwhelmed by an extraction process in which the pure concentrate of the scent molecule is produced, e.g., pure Nepetalactone, as in the process described in U.S. Pat. No. 6,524,605 to Coats, et al. and its related published application 20030138471. Simply, the natural setting has few available mechanisms that will duplicate the teachings of Coats, et al. and the dispersal of this pure extract will simply overwhelm any other competing scents. For these reasons each of the essential oils or scent constituents of the above inventive formulation are obtained by conventional boiling and distillation of the process products like those described in U.S. Pat. No. 5,567,436 to Udelle. Of course, such distillation more closely matches a natural process much broader molecular spectra are produced which, when mixed according to the above formulations, confuse the olfactory structure of a large animal but are fully discernible by the sensing structures of an insect.

### DESCRIPTION OF THE SPECIFIC EXAMPLES

While the following teachings illustrate examples of oil and soap carried inventive repellent formulations many other modes of application thereof to the body surfaces of a user are contemplated as are applications of the inventive essential oil mixture to articles of clothing, furniture and/or various dispersant surfaces like the heating or air conditioning air filters found in a home. In each instance, however, the inventive formulation seeks to preserve the broad spectra of each scent, including those that effect masking, rather than any single refined extract, with the mixture including sufficient amounts of Nepeta cataria to be perceived by the sensing mechanisms of an insect. Accordingly, both illustrative examples include the following primary scent mixture, expressed in arbitrary unit ratios:

| | | |
|---|---|---|
| Catnip | [Nepeta Cataria] | 6.5 to 7.5 units |
| Lemongrass | [Cymbopogen Flexuosus] | 2.0 to 2.5 units |
| Tea tree | [Melaleuca Alternifolia] | 2.8 to 3.2 units |

to which the following further scent oils may be admixed, again in same unit ratios:

| | | |
|---|---|---|
| Citronella | [Cymbopogen Nardus] | 1.2 to 1.7 units |
| Lavender | [Lavendula Officinalis] | 1.0 to 1.3 units |

In each instance the essential oils are obtained in a process substantially like that described in U.S. Pat. No. 5,567,436 to Udelle and reference to the teachings thereof is therefore now adopted. Unlike Udelle, however, it is the distillates of the short boiling cycle that are collected, and not the mixture itself, thus concentrating the lower boiling point constituents that typically include the primary scent carriers, or the aromatics, which are believed to be the primary molecules that trigger the insect's sensors.

### Example 1

Blend in a mechanical shredder or blender a mixture of 6.5 to 7.5 units of Catnip [Nepeta Cataria]; 2.0 to 2.5 units of freshly shredded lemongrass [Cymbopogen Flexuosus]; 2.8 to 3.2 units of freshly shredded tea tree [Melaleuca Alternifolia]; 1.2 to 1.7 units of shredded citronella [Cymbopogen Nardus]; and 1.0 to 1.3 units of shredded lavender [Lavendula Officinalis] until finely mixed. Pour the blended mixture into a container of about 100 units of ordinary tap water while mixing and bring the water to boiling. Maintain the mixture boiling until approximately 10% of its volume is boiled off through a distillation coil with its outlet fully submerged in 80 to 100 units of canola oil to a depth of at least 10 centimeters. Before cooling, the canola oil containing the boiled off products of the mixture may then be admixed with up to 20 units of olive oil and thereafter poured into dispensers for use.

### Example 2

Introduce into the warm product of the process described in Step 1 a thin stream of a 1:1 solution of water and lye, or sodium hydroxide, while stirring in one direction. As the fats are thus hydrogenated one may saponify the lye water and oil mixture with a hand held stick blender and thereafter pour into individual molds to solidify as soap bars. When solid each soap bar may be wrapped for vending.

It will be appreciated that in both examples some water vapor is already entrained in the oil as result of the submerged release of the boiling vapors into the canola oil column. Thus some hydrogenation will invariably result in both processes, producing some sedimentary matter as result of the presence of carbon dioxide and traces of sodium chloride in the water and the ambient air (sodium carbonate). These solids precipitate on the user's skin surfaces to provide a persistent residue of the scent in size spectra that are particularly discernible by an insect. In this manner a skin applicant including variously sized sediments and molecular combinations is devised that is both repelling to the insects and to those animals that are attracted by catnip.

Obviously many modifications and variations of the instant invention can be effected without departing from the spirit of the teachings herein. It is therefore intended that the scope of the invention be determined solely by the claims appended hereto.

It is claimed:

1. A method of producing a skin ointment useful in repelling both insects and also larger carnivorous mammal species comprising the steps of:
mixing insect repelling plant matter with animal repelling plant matter;
shredding while agitating the mixed insect and animal repelling plant matter to produce a a substantially homogenous fine mixture thereof;
hydrating the homogenous mixture; and
introducing the essential oils and vapor from the hydrated mixture into a quantity of plant oil.

2. A method according to claim 1, wherein:
said insect repelling plant matter includes the catnip plant.

3. A method according to claim 2, wherein:
said animal repelling plant matter includes the lemongrass plant.

4. A method according to claim 3, wherein:
said mixture of insect repelling plant matter and animal repelling plant matter further includes the citronella plant.

5. A method of producing a soap for depositing onto a person's skin a sediment useful in repelling both insects and also larger carnivorous mammal species comprising the steps of:
mixing insect repelling plant matter with animal repelling plant matter;
shredding while agitating the mixed insect and animal repelling plant matter to produce a a substantially homogenous fine mixture thereof;
hydrating the homogenous mixture;
introducing the essential oils and vapor from the hydrated mixture into a quantity of plant oil;
admixing into the combination of the essential oils and vapor and plant oil a quantity of lye; and
saponifying the admixed combination of essential oils, plant oil and lye.

6. A method according to claim 5 comprising the further step of:
deposing the saponified product into molds.

7. A method according to claim 6, wherein:
said insect repelling plant matter includes the catnip plant.

8. A method according to claim 7, wherein:
said animal repelling plant matter includes the lemongrass plant.

9. A method according to claim 8, wherein:
said mixture of insect repelling plant matter and animal repelling plant matter further includes the citronella plant.
